(19) United States
(12) Patent Application Publication
(10) Pub. No.: US 2004/0138999 A1
(43) Pub. Date: Jul. 15, 2004

(54) Systems and methods for managing a credit account having a credit component associated with healthcare expenses

(75) Inventors: Howard S. Friedman, Washington, DC (US); Seth B. Blackley, Arlington, VA (US); Adam Braff, Washington, DC (US); William A. Cilluffo II, Vienna, VA (US); Richard C. Edmunds III, Alexandria, VA (US); Tilman D.T. Ehrbeck, Washington, DC (US); Chris Newkirk, Washington, DC (US); Ronald D. Sheklin, Arlington, VA (US)

Correspondence Address: Finnegan, Henderson, Farabow,, Garrett & Dunner, L.L.P, 1300 I Street, N.W., Washington, DC, 20005-3315, US

(73) Assignee: Capital One Financial Corporation

(21) Appl. No.: 10/340,784

(22) Filed: Jan. 13, 2003

(51) Int. Cl. G06F 17/60

(52) U.S. Cl. 705/39; 705/40

(57) ABSTRACT

A method for managing a credit account associated with a customer is provided. The credit account has a first credit component associated with purchase transactions and a second credit component associated with healthcare expenses. A payment request from an insurance provider for a customer payment portion associated with a particular healthcare expense is received. A determination is made to see whether the customer payment portion exceeds a limit. The insurance provider is paid the customer payment portion when the limit is not exceeded. The payment of the customer payment portion is requested from a healthcare expense account.

### BACKGROUND OF THE INVENTION

I. Field of the Invention

The present invention generally relates to the field of management of financial accounts, such as credit card accounts. More particularly, the invention relates to systems and methods for managing a credit account having a credit component associated with healthcare expenses.

II. Background and Material Information

Traditionally, consumers of products and services have relied on credit cards to make purchases based on credit. Such consumers have also sometimes relied on a debit card associated with a healthcare expense account, such as a medical savings account or a flexible spending account to pay for health related expenses. Such reliance on different financial products causes consumers to rely on different service providers for their needs. It also results in the consumers having to monitor their healthcare expense account so that they do not attempt to withdraw more funds than available in the healthcare expense account.

Accordingly, there is a need for managing a credit account associated with a customer that makes the purchase of goods and services, including healthcare expenses more efficient.

### SUMMARY OF THE INVENTION

Systems and methods consistent with embodiments of the present invention facilitate the management of a credit account associated with a customer, where the credit account has a first credit component associated with purchase transactions and a second credit component associated with healthcare expenses.

In accordance with embodiments of the invention, methods for managing such credit accounts are provided. According to one embodiment of the invention, a method for managing a credit account associated with a customer, where the credit account has a first credit component associated with purchase transactions and a second credit component associated with healthcare expenses, is provided. The method comprises receiving a payment request from an insurance provider for a customer payment portion associated with a particular healthcare expense. The method may further comprise determining whether the customer payment portion exceeds a limit. The method may further include paying the insurance provider the customer payment portion when the limit is not exceeded. And the method may further comprise requesting payment of the customer payment portion from a healthcare expense account.

According to another embodiment of the invention, a method for managing a credit account associated with a customer, where the credit account has a first credit component associated with purchase transactions and a second credit component associated with healthcare expenses, is provided. The method comprises receiving a payment request for an account transaction. The method further comprises determining whether the account transaction is for a healthcare expense associated with the second credit component. If the account transaction is a healthcare expense, then the method determines whether the payment exceeds an account limit associated with the second credit component. If the account transaction is a purchase transaction associated with the first credit component, then the method allocates the purchase transaction to the first credit component.

According to yet another embodiment of the invention a method for managing a credit account associated with a customer, where the credit account has a first credit component associated with purchase transactions and a second credit component associated with healthcare expenses, is provided. The method comprises receiving a payment request for an account transaction. The method further comprises determining whether the account transaction is for a healthcare expense associated with the second credit component and requesting payment for the healthcare expense from a healthcare expense account, when the account transaction is a healthcare expense. The method further comprises receiving a payment for the healthcare expense from the healthcare expense account, when it is determined that the healthcare expense account has sufficient funds available to pay for at least a part of the healthcare expense. When sufficient funds to pay for the healthcare expense are not available in the healthcare expense account, a determination is made to see whether the second credit component has credit available for paying at least a portion of the healthcare expense. The method further comprises fulfilling the payment request using the credit available in the second credit component, when credit is available in the second credit component.

According to another embodiment of the invention, a system for managing a credit account associated with a customer, where the credit account has a first credit component associated with purchase transactions and a second credit component associated with healthcare expenses, is provided. Such a system comprises means for receiving a request from an insurance provider for a customer payment portion associated with a particular healthcare expense. The system may further include means for determining whether the customer payment portion exceeds a limit. Additionally, the system may include means for paying the insurance provider the customer payment portion when the account limit is not exceeded. Also, the system may include means for requesting payment of the customer payment portion from a healthcare expense account.

According to yet another embodiment of the invention, a system for managing a credit account associated with a customer, where the credit account has a first credit component associated with purchase transactions and a second credit component associated with healthcare expenses, is provided. Such a system comprises means for receiving a payment request for an account transaction. The system further comprises means for determining whether the account transaction is for a healthcare expense associated with the second credit component. The system may further include means for determining whether the payment exceeds an account limit associated with the second credit component, if the account transaction is a healthcare expense. The system may further include means for allocating the purchase transaction to the first credit component, if the account transaction is a purchase transaction associated with the first credit component.

According to still another embodiment of the invention, a system for managing a credit account associated with a customer, where the credit account has a first credit component associated with purchase transactions and a second credit component associated with healthcare expenses, is provided. The system comprises means for receiving a payment request for an account transaction. The system further comprises means for determining whether the account transaction is for a healthcare expense associated with the second credit component. The system further comprises means for requesting payment for the healthcare expense from a healthcare expense account, when the account transaction is a healthcare expense. The system may further include means for receiving a payment for the healthcare expense from the healthcare expense account, when it is determined that the healthcare expense account has sufficient funds available to pay for at least a part of the healthcare expense. Additionally, the system may include means for determining whether the second credit component has credit available for paying at least a part of the healthcare expense, when sufficient funds to pay for the healthcare expense are not available in the healthcare expense account. Also, the system may further include means for fulfilling the payment request using the credit available in the second credit component, when credit is available in the second credit component.

Both the foregoing general description and the following detailed description are exemplary and are intended to provide further illustration and explanation of the embodiments of the invention as claimed.

### BRIEF DESCRIPTION OF THE DRAWINGS

The accompanying drawings, which are incorporated in and constitute a part of this specification, illustrate various embodiments and aspects of the present invention. In the drawings:

FIG. 1 illustrates an exemplary system environment, consistent with embodiments of the present invention;

FIG. 2 shows an exemplary computing platform at a financial institution, consistent with embodiments of the present invention;

FIG. 3 shows a flowchart of an exemplary method for managing a credit account associated with a customer, consistent with embodiments of the present invention;

FIG. 4 shows a flowchart of an exemplary method for managing a credit account associated with a customer, consistent with embodiments of the present invention; and

FIG. 5 shows a flowchart of an exemplary method for managing a credit account associated with a customer, consistent with embodiments of the present invention.

### DETAILED DESCRIPTION

Systems and methods consistent with embodiments of the present invention manage a credit account associated with a customer, where the credit account has a first credit component associated with purchase transactions and a second credit component associated with healthcare expenses. Consistent with the embodiments of the invention, the system may receive a payment request from an insurance provider for a customer payment portion associated with a particular healthcare expense. The system may then determine whether the customer payment portion exceeds a limit associated with the second credit component. If not, the insurance provider is paid the customer payment portion, which may be requested from a healthcare expense account.

In one embodiment consistent with the present invention, the first credit component and the second credit component may have different features. Thus, the two credit components may have different annual percentage rates, credit limits, and fee structures. Of course, these features may also be identical or different only in some respects.

Embodiments of the invention may be implemented in various system or network environments. Such environments and applications may be specially constructed for performing the various processes and operations of the embodiments of the invention or they may include a general-purpose computer or computing platform selectively activated or reconfigured by program code to provide the necessary functionality. The systems and methods disclosed herein are not inherently related to any particular computer or other apparatus, and may be implemented by a suitable combination of hardware, software, and/or firmware. For example, various general-purpose machines may be used with programs written in accordance with teachings of the embodiments of the invention, or it may be more convenient to construct a specialized apparatus or system to perform the required methods and techniques.

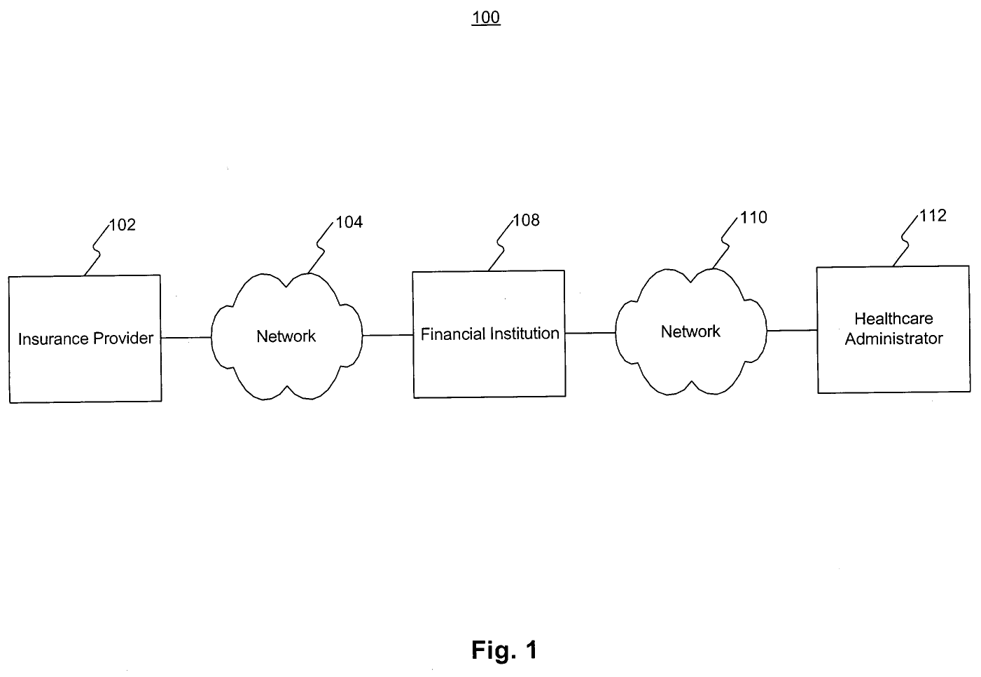

FIG. 1 is an illustration of an exemplary system environment 100, consistent with embodiments of the present invention. As shown in FIG. 1, the exemplary system environment may include an insurance provider 102 connected via a network 104 to a financial institution 108. The financial institution 108 may be connected via another network 110 to a healthcare administrator 112. Although FIG. 1, shows two different networks, the components shown in FIG. 1 may be connected using the same network. Indeed, an insurance provider may be resident at the same site as the financial institution, or may be a part of the financial institution, thereby obviating the need for a network connection between the two. Similarly, healthcare administrator 112 may also be either a part of the financial institution or be resident at the same site as the financial institution. Also, although not shown in FIG. 1, a healthcare expense account may also be located at financial institution 108.

Although not shown in FIG. 1, network 104 may also be used to exchange information between any merchant of goods and/or services and financial institution 108. Thus, network 104 may be used to receive request for payment related to an account transaction from a merchant. A credit card account to cover the transactions may be issued by financial institution 108.

Examples of networks that may be used to exchange information among the various components of FIG. 1 include public networks such as the Internet, telephony networks, courier networks (e.g., postal service, United Parcel Service, Federal Express, etc.), private networks, virtual private networks, local area networks, metropolitan area networks, wide area networks, ad hoc networks, or any other mechanism for permitting communication between remote sites, regardless of whether the connection is wired or wireless. Thus, the present invention can be used in any environment where information may be exchanged by any means among the various components, including, for example the insurance provider, the financial institution, and the healthcare administrator.

In one embodiment consistent with the present invention, the Visa/MasterCard Interchange may be used to exchange information between insurance provider 102 and financial institution 104. In such an embodiment, an interchange fee may be shared between the financial institution and the insurance provider. Alternatively, instead of the Visa/MasterCard Interchange, a private link may be used for exchange of information between the financial institution and the insurance provider.

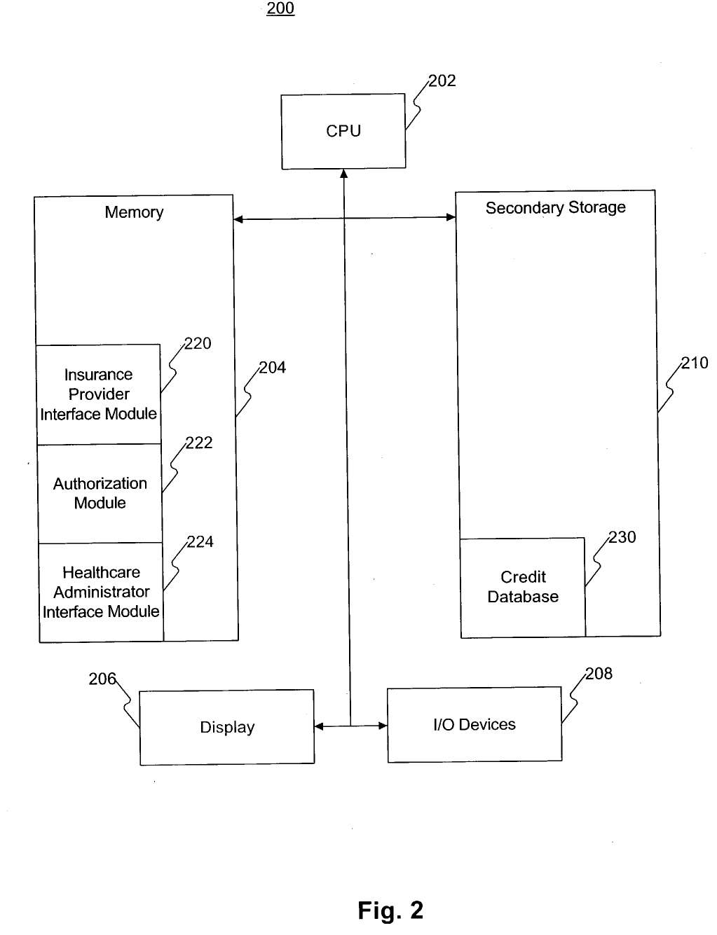

FIG. 2 shows an exemplary computing platform 200, which may be located at financial institution 108, consistent with embodiments of the present invention. As shown in FIG. 2, computing platform 200 may include a CPU 202, a memory 204, a display 206, I/O devices 208, and a secondary storage 210. Although FIG. 2 depicts only one CPU, one skilled in the art will appreciate that other processors may be used as part of the system. Memory 204 may include an insurance provider interface module 220, an authorization module 222, and a healthcare administrator interface module 224. Insurance provider interface module 220 may, which in one embodiment interfaces with insurance provider 102, alone or in conjunction with other software, such as an operating system, receive information related to a payment request for a customer payment portion associated with a healthcare expense. Insurance provider interface module 220 may be implemented in software using any programming language and it may include or interface with program libraries, application program interfaces, operating systems, or other software. Insurance provider interface module 220 may further be used by a human agent to receive a payment request. Conversely, the human agent may receive such a payment request without using the insurance provider interface module.

Authorization module 222 may determine credit limits. Thus, for example, authorization module 222 may determine whether the customer payment portion exceeds a limit associated with the second credit component. Authorization module may be implemented in software using any programming language and it may include or interface with program libraries, application program interfaces, operating systems, or other software. In one embodiment consistent with the present invention, the authorization module may comprise BASE24 made by Transaction Systems Architects, Inc., of Omaha, Nebr.

Healthcare administrator interface module 224 may, which in one embodiment may interface with healthcare administrator 112, alone or in conjunction with other software, such as an operating system, help the financial institution request payment of the customer payment portion from a healthcare expense account. Healthcare administrator interface module 222 may be implemented in software using any programming language and it may include or interface with program libraries, application program interfaces, operating systems, or other software. Healthcare administrator interface module 222 may further be used by a human agent to request payment of the customer payment portion from a healthcare expense account. Conversely, the human agent may request such a payment without using the healthcare administrator interface module.

Secondary storage 210, which is connected to other parts of the exemplary system of FIG. 2, may be implemented with a storage device, such as a high-density memory or storage device. Secondary storage 210 may be either directly connected to the rest of the system, or indirectly connected via a communication network, such as a local area network, or the Internet. Also, the data residing in the databases and tables stored in secondary storage 210 may be distributed over various databases or tables. Secondary storage 210 may further include credit database 230. Credit database 230 may contain credit information concerning existing credit accounts managed by financial institution 108.

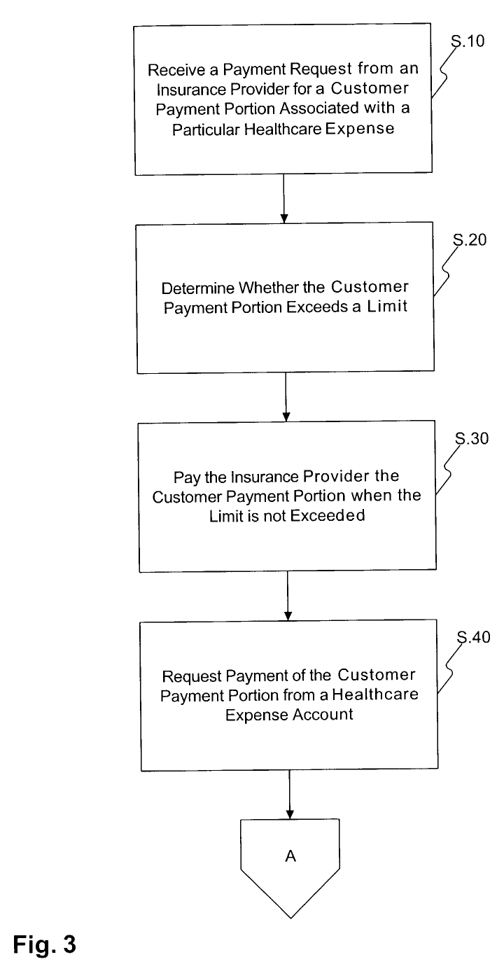

FIG. 3 shows a flowchart of an exemplary method for managing a credit account associated with a customer, where the credit account has a first credit component associated with purchase transactions and a second credit component associated with healthcare expenses, consistent with embodiments of the present invention. The features and functionality of this exemplary method may be implemented by insurance provider interface module 220, authorization module 222, and healthcare administrator interface module 224, when executed by CPU 202 (see FIG. 2). In one implementation, insurance provider interface module 220 may, alone or in combination with other modules, receive a request from an insurance provider for a customer payment portion associated with a particular healthcare expense account. Further, authorization module 222, alone or in combination with healthcare administrator interface module 224, may execute the remaining steps of the exemplary method depicted in FIG. 3. These modules and their corresponding functionality may be combined into one module or may be distributed into other modules to perform the steps corresponding to the exemplary method of FIG. 3, consistent with embodiments of the present invention.

As illustrated in FIG. 3, the process begins when a payment request for a customer payment portion associated with a particular healthcare expense is received from an insurance provider (step S.10). Such request may include, for example, the name of the insurance provider, the name of the customer, the amount of customer payment portion, and/or the type of healthcare expense. This request may come from the insurance provider or an agent of the insurance provider. As used herein the term “insurance provider” includes, but is not limited to, a health maintenance organization (“HMO”), a preferred provider organization (“PPO”), Medicare, Medicaid, or any other entity that may provide coverage for healthcare expenses. Also, as used herein the term “customer payment portion” includes, but is not limited to, a co-pay portion associated with a healthcare expense, a deductible associated with a healthcare expense, and/or co-insurance portion of the healthcare expense.

Next, in one embodiment, authorization module 222 may determine whether the customer payment portion exceeds a limit (step S.20). This determination may be made by the software associated with the authorization module or it may be made by examining the output from the authorization module. As used herein the term “limit” includes, but is not limited to, the aggregate of funds available to the customer through her second credit component and the funds available in a healthcare expense account associated with the customer, the balance available in the second credit component, and/or the funds available in the healthcare expense account associated with the customer. In some circumstances, funds available in the first credit component may also be used to cover the healthcare expenses.

As part of this step, the customer's credit limit may also be taken into consideration. Also, credit limit, the maximum amount that a lender has agreed to a customer, includes a fixed credit limit, such as $5,000, but it is not so limited. The limit associated with the second credit component may be determined using statistical or other decision logic techniques and thus may be dynamically based on the degree of risk of offering credit to the customer. Also, as part of this step, the degree and the immediacy of the need of the customer may also be taken into account.

Next, in one embodiment, authorization module 222 may pay the insurance provider the customer payment portion when the limit is not exceeded (step S.30). As part of this step, the payment may be charged to the second credit component. The insurance provider may be paid using any of the ways for making a payment, including sending a check via mail, a wire transfer, or via the Internet. Further, as used herein the term “pay” includes actual payment, but is not so limited. The term “pay” also includes, for example, setting a flag in a software to indicate payment, sending a message to another module indicating payment authorization, and/or sending a message to a third party contractor indicating payment authorization. Also, this step may include notifying healthcare administrator interface module 224 of the payment authorization and/or the subsequent payment.

Next, in one embodiment, healthcare administrator interface module 224 may request payment of the customer payment portion from a healthcare expense account (step S.40). In one embodiment, this payment may be used to cover the credit extended from the second credit component. As used herein the term “healthcare expense account” includes, but is not limited to a flexible healthcare spending account, a medical savings account, a dependent care expense account, a healthcare reimbursement account, and/or any other type of savings account (dedicated or shared) established for covering healthcare expenses. Of course, where a savings account is used to cover healthcare expenses, the healthcare administrator may request payment from a bank or a similar financial institution.

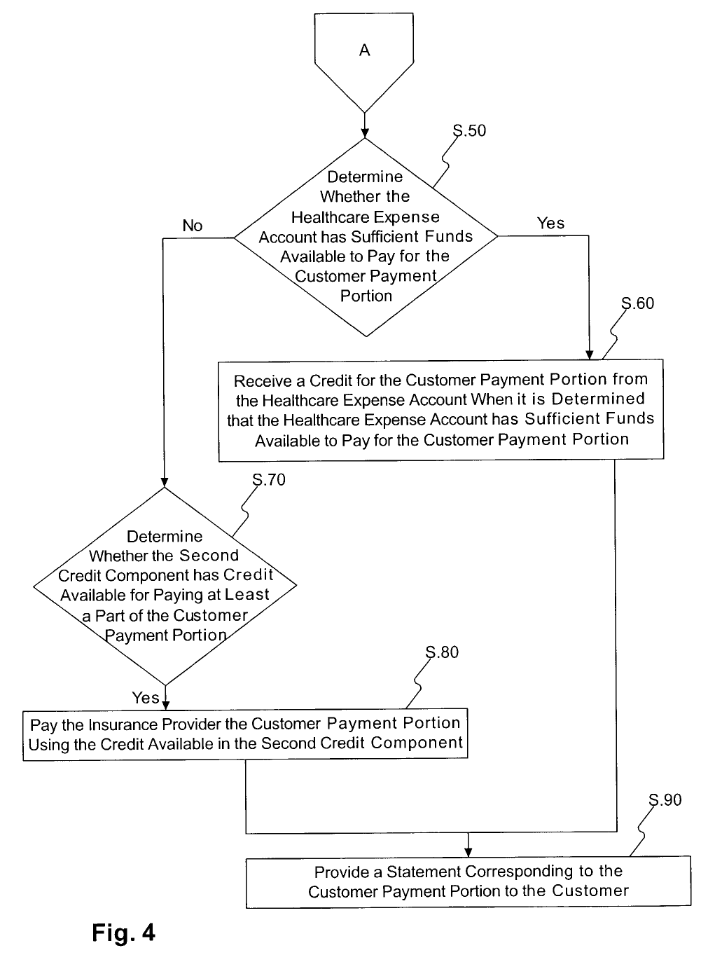

Referring now to FIG. 4, a flowchart corresponding to an exemplary method for managing a credit account associated with a customer is shown. In one embodiment, some of the steps shown in FIG. 4 may be accomplished after completing the steps shown in FIG. 3. For example, when a healthcare expense account administrator receives a request for payment of the customer payment portion, a determination may be made as to whether the healthcare expense account has sufficient funds available to pay for the customer payment portion (step S.50). In one embodiment, healthcare administrator interface module 224 may query the operator of the healthcare expense account in real-time to determine whether sufficient funds are available to pay for the customer payment portion. Alternatively, the healthcare administrator interface module 224 may accomplish this in a batch-mode by determining the sufficiency of funds based on previously stored information concerning the healthcare expense account. Then, later, the healthcare administrator interface module 224 may obtain updated information from an operator of the healthcare expense account and it may also update the operator with the new information.

Further, in one embodiment, the entity responsible for management of the credit account may receive a credit for the customer payment portion from the healthcare expense account, when it is determined that that the healthcare expense account has sufficient funds available to pay for the customer payment portion (step S.60). If, on the other hand, the healthcare expense account does not have sufficient funds available to pay for the customer payment portion, then a determination may be made to ascertain whether the second credit component has credit available for paying at least a part of the customer payment portion (step S.70). As part of this step, the funds available in the healthcare expense account may be combined with the credit available in the second credit component. Subsequently, in one embodiment, the insurance provider may be paid using the credit available in the second credit component (step S.80).

In one embodiment, a statement corresponding to the customer payment portion may be provided to the customer regardless of whether the healthcare expense account has sufficient funds (step S.90). The statement provided to the customer may include account balance information for the healthcare expense account, such as a flexible spending account statement. Additionally, the statement may include balance information concerning the first credit component and the second credit component of the credit account.

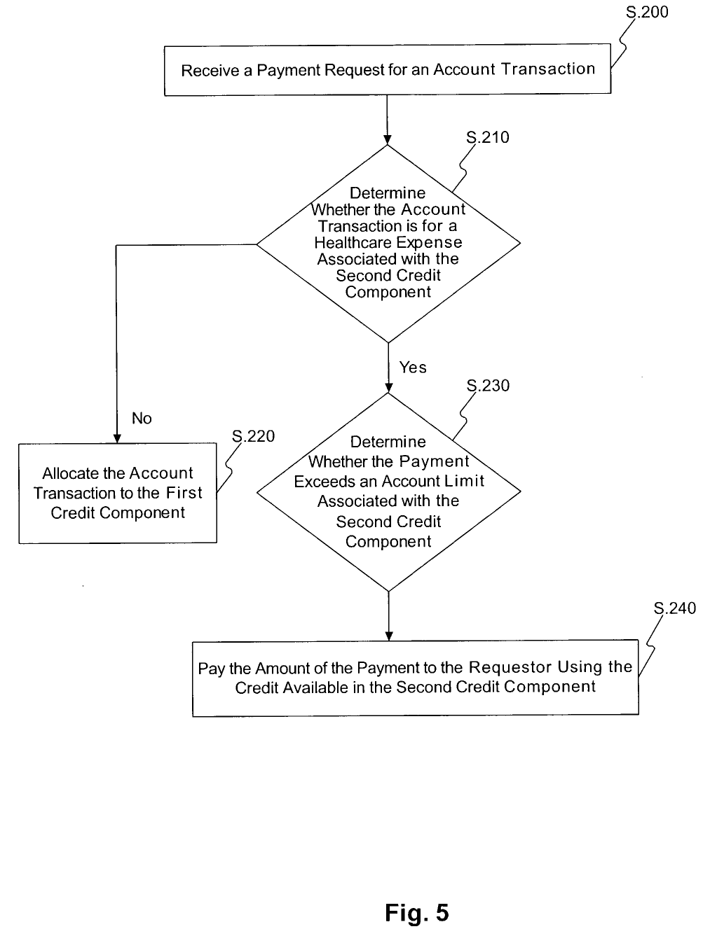

Referring now to FIG. 5, another embodiment for managing a credit account for a customer, where the credit account has a first credit component associated with purchase transactions and a second credit component associated with purchase transactions is provided. As illustrated in FIG. 5, the process begins when a payment request for an account transaction is received (step S.200). Such a request may include, for example, the name of the customer to whose account the transaction relates to, the amount of the transaction, and/or the type of the account transaction. This request may come from a transaction that may take place at a store, at a physician's office, over the telephone, via the Internet, or any other means for executing an account transaction.

Next, in one embodiment, authorization module 222 may determine whether the account transaction is for a healthcare expense associated with the second credit component (step S.210). This determination may be made by the software associated with authorization module 222 or it may be made by examining the output from the authorization module. In one embodiment, an account transaction may be determined to be a healthcare expense related transaction based on an identification of the merchant associated with the account transaction. Thus, for example, an account transaction may be classified as associated with a healthcare expense when a medical provider or an insurer is associated with the account transaction. The identity of the merchant may be ascertained by authorization module 222 and/or associated software/hardware by using, for example, unique identification numbers associated with the insurers and/or medical providers and a corresponding look up table comprising the identification numbers. The identity of the insurer may also be determined by associating a code attached to all payment requests, which may indicate the nature of the merchant.

In another embodiment consistent with the invention, the account transaction may be determined as related to a healthcare expense based on information obtained from the customer. Thus, the customer may, via any communication means, such as telephone, electronic mail, or the Internet, indicate to the manager of the credit card account the nature of an account transaction. In a yet another embodiment, the nature of the account transaction may be determined based on a standard industrial classification associated with the account transaction. It may also be determined based on a merchant category code associated with the account transaction. Alternatively, the nature of the account transaction may also be determined by analyzing a stock keeping unit (SKU) associated with the account transaction. In general, consistent with the present invention, any means which may help determine whether the account transaction is related to a healthcare expense may be used. This determination may be made by the software associated with the authorization module or it may be made by examining the output from the authorization module and/or additional software.

Next, in one embodiment, if the account transaction is not for a healthcare expense associated with the second credit component, then the account transaction may be allocated to the first credit component (step S.220). In one embodiment, the authorization module may allocate the account transaction to the first credit component. Alternatively, the allocation to the first credit component may be made by some other software either by itself or in conjunction with the authorization module.

If, however, the account transaction is for a healthcare expense associated with the second credit component, then a determination is made to see whether the payment exceeds an account limit associated with the second credit component (step S.230). This determination may be made by the software associated with the authorization module or it may be made by examining the output from the authorization module. Also, as used herein the term “limit” includes a fixed credit limit, such as $5,000, but it is not so limited. The limit associated with the second credit component may be determined using statistical or other decision logic techniques and thus may be based on the degree of risk of offering credit to the customer.

Further, in one embodiment consistent with the present invention, healthcare administrator interface module 224 may request payment of the account transaction from a healthcare expense account when the account transaction is for a healthcare expense. Additionally, healthcare administrator interface module 224 may determine whether the healthcare expense account has sufficient funds available to pay for the account transaction. As part of this step the healthcare administrator interface module 224 may request the status of the healthcare expense, such as the account balance of the healthcare expense account, from an operator of the healthcare expense account. Also, in one embodiment, the manager of the credit card account may receive a credit for the account transaction from the healthcare expense account when it is determined that the healthcare expense account has sufficient funds available to pay for the account transaction.

Next, in one embodiment consistent with the invention, authorization module 222 pays the amount of the payment to the requester using the credit available in the second credit component (step S.240). As used herein the term “pays” includes actual payment, but is not so limited. The term “pays” also includes, for example, setting a flag in a software to indicate payment, sending a message to another module indicating payment authorization, and/or sending a message to a third party contractor indicating payment authorization.

Referring now to FIG. 4, the steps shown in FIG. 4 may be accomplished after completing the steps shown in FIG. 5. For example, after the requestor is paid (step S.240), a determination may be made as to whether the healthcare expense account has sufficient funds available to pay for the customer payment portion as in step S.50. In one embodiment, one may query the operator of the healthcare expense account in real-time to determine whether sufficient funds are available to pay for the customer payment portion. Alternatively, one may accomplish this in a batch-mode by determining the sufficiency of funds based on previously stored information concerning the healthcare expense account.

Further, in one embodiment, the entity responsible for management of the credit account may receive a credit for the account transaction from the healthcare expense account, when it is determined that that the healthcare expense account has sufficient funds available to pay for the account transaction as, for example, in step S.60. If, on the other hand, the healthcare expense account does not have sufficient funds available to pay for the account transaction, then a determination may be made to ascertain whether a combination of the funds available in the healthcare expense account and the credit available in the second credit component may be used to pay for the account transaction.

Further, in one embodiment, authorization module 222 may provide a statement corresponding to the account transaction to the customer, as described above with respect to step S.90 of FIG. 3.

Other modifications and embodiments of the invention will be apparent to those skilled in the art from consideration of the specification and practice of the invention disclosed herein. For example, one skilled in the art will appreciate that the systems and methods consistent with the present invention may be distributed among various components over various computers. Further, although embodiments of the invention have been described herein with reference to financial products or services, systems and methods consistent with embodiments of the invention may also be adapted for any other type of service or product.

What is claimed is:

1. A method for managing a credit account associated with a customer, wherein the credit account has a first credit component associated with purchase transactions and a second credit component associated with healthcare expenses, the method comprising:
receiving a payment request from an insurance provider for a customer payment portion associated with a particular healthcare expense;
determining whether the customer payment portion exceeds a limit;
paying the insurance provider the customer payment portion when the limit is not exceeded; and
requesting payment of the customer payment portion from a healthcare expense account.

2. The method of claim 1, further comprising:
determining whether the healthcare expense account has sufficient funds available to pay for the customer payment portion.

3. The method of claim 2, further comprising:
receiving a credit for the customer payment portion from the healthcare expense account when it is determined that the healthcare expense account has sufficient funds available to pay for the customer payment portion.

4. The method of claim 2, when the healthcare expense account does not have sufficient funds available to pay for the customer payment portion, further comprising:
determining whether the second credit component has credit available for paying at least a part of the customer payment portion; and
when credit is available, paying the insurance provider the customer payment portion using the credit available in the second credit component.

5. The method of claim 2, further comprising:
providing a statement corresponding to the customer payment portion to the customer.

6. A method for managing a credit account associated with a customer, wherein the credit account has a first credit component associated with purchase transactions and a second credit component associated with healthcare expenses, the method comprising:
receiving a payment request for an account transaction;
determining whether the account transaction is for a healthcare expense associated with the second credit component;
if the account transaction is a healthcare expense, then determining whether the payment exceeds an account limit associated with the second credit component; and
if the account transaction is a purchase transaction associated with the first credit component, then allocating the purchase transaction to the first credit component.

7. The method of claim 6, wherein determining whether the account transaction is for a healthcare expense associated with the second credit component is based on an identification of the merchant associated with the account transaction.

8. The method of claim 7, wherein the account transaction is determined to be for a healthcare expense when at least one of an insurer and a medical provider is identified as associated with the account transaction.

9. The method of claim 7, wherein determining whether the account transaction is for a healthcare expense is based on information about the transaction obtained from the customer.

10. The method of claim 7, wherein determining whether the account transaction is for a healthcare expense further includes:
determining whether the account transaction is for a healthcare expense based on at least one of a standard industrial classification associated with the account transaction, a merchant category code associated with the account transaction, and a stock keeping unit (SKU) associated with the account transaction.

11. The method of claim 6, further comprising:
requesting payment of the account transaction from a healthcare expense account when the account transaction is for a healthcare expense.

12. The method of claim 11, further comprising:
determining whether the healthcare expense account has sufficient funds available to pay for the account transaction.

13. The method of claim 12, further comprising:
receiving a credit for the account transaction from the healthcare expense account when it is determined that the healthcare expense account has sufficient funds available to pay for the account transaction.

14. The method of claim 12, further comprising:
providing a statement corresponding to the account transaction to the customer.

15. The method of claim 12, when the healthcare expense account does not have sufficient funds available to pay for the account transaction, further comprising: determining whether the second credit component has credit available for paying at least a part of the account transaction; and
when credit is available paying the merchant for the account transaction using the credit available in the second credit component.

16. A method for managing a credit account associated with a customer, wherein the credit account has a first credit component associated with purchase transactions and a second credit component associated with healthcare expenses, the method comprising:
receiving a payment request for an account transaction;
determining whether the account transaction is for a healthcare expense associated with the second credit component;
requesting payment for the healthcare expense from a healthcare expense account, when the account transaction is a healthcare expense;
receiving a payment for the healthcare expense from the healthcare expense account, when the healthcare expense account has sufficient funds available to pay for at least a part of the healthcare expense;
when sufficient funds to pay for the healthcare expense are not available in the healthcare expense account, determining whether the second credit component has credit available for paying at least a part of the healthcare expense; and
when credit is available in the second credit component, fulfilling the payment request using the credit available in the second credit component.

17. A system for managing a credit account associated with a customer, wherein the credit account has a first credit component associated with purchase transactions and a second credit component associated with healthcare expenses, the system comprising:
means for receiving a request from an insurance provider for a customer payment portion associated with a particular healthcare expense;
means for determining whether the customer payment portion exceeds a limit;
means for paying the insurance provider the customer payment portion when the limit is not exceeded; and
means for requesting payment of the customer payment portion from a healthcare expense account.

18. The system of claim 17, further comprising:
means for determining whether the healthcare expense account has sufficient funds available to pay for the customer payment portion.

19. The system of claim 18, further comprising:
means for receiving a credit for the customer payment portion from the healthcare expense account when the healthcare expense account has sufficient funds available to pay for the customer payment portion.

20. The system of claim 18, when the healthcare expense account does not have sufficient funds available to pay for the customer payment portion, further comprising:
means for determining whether the second credit component has credit available for paying at least a part of the customer payment portion; and
when credit is available, means for paying the insurance provider the customer payment portion using the credit available in the second credit component.

21. The system of claim 18, further comprising:
means for providing a statement corresponding to the customer payment portion to the customer.

22. A system for managing a credit account associated with a customer, wherein the credit account has a first credit component associated with purchase transactions and a second credit component associated with healthcare expenses, the system comprising:
means for receiving a payment request for an account transaction;
means for determining whether the account transaction is for a healthcare expense associated with the second credit component;
if the account transaction is a healthcare expense, then means for determining whether the payment exceeds an account limit associated with the second credit component; and
if the account transaction is a purchase transaction associated with the first credit component, then means for allocating the purchase transaction to the first credit component.

23. The system of claim 22, wherein determining whether the account transaction is for a healthcare expense associated with the second credit component is based on an identification of the merchant associated with the account transaction.

24. The system of claim 22, wherein the account transaction is determined to be for a healthcare expense when at least one of an insurer and a medical provider is identified as associated with the account transaction.

25. The system of claim 22, wherein determining whether the account transaction is for a healthcare expense is based on information about the transaction obtained from the customer.

26. The system of claim 22, wherein means for determining whether the account transaction is for a healthcare expense further includes: means for determining whether the account transaction is for a healthcare expense based on at least one of a standard industrial classification associated with the account transaction, a merchant category code associated with the account transaction, and a stock keeping unit (SKU) associated with the account transaction.

27. The system of claim 22, further comprising:
means for requesting payment of the account transaction from a healthcare expense account when the account transaction is for a healthcare expense.

28. The system of claim 27, further comprising:
determining whether the healthcare expense account has sufficient funds available to pay for the account transaction.

29. The system of claim 27, further comprising:
means for receiving a credit for the account transaction from the healthcare expense account when it is determined that the healthcare expense account has sufficient funds available to pay for the account transaction.

30. The system of claim 27, further comprising:
means for providing a statement corresponding to the account transaction to the customer.

31. The system of claim 27, when the healthcare expense account does not have sufficient funds available to pay for the account transaction, further comprising:
means for determining whether the second credit component has credit available for paying at least a part of the account transaction; and
when credit is available means for paying the merchant for the account transaction using the credit available in the second credit component.

32. A system for managing a credit account associated with a customer, wherein the credit account has a first credit component associated with purchase transactions and a second credit component associated with healthcare expenses, the system comprising:
means for receiving a payment request for an account transaction;
means for determining whether the account transaction is for a healthcare expense associated with the second credit component;
means for requesting payment for the healthcare expense from a healthcare expense account, when the account transaction is a healthcare expense;
means for receiving a payment for the healthcare expense from the healthcare expense account, when the healthcare expense account has sufficient funds available to pay for at least a part of the healthcare expense;
when sufficient funds to pay for the healthcare expense are not available in the healthcare expense account, means for determining whether the second credit component has credit available for paying at least a part of the healthcare expense; and
when credit is available in the second credit component, means for fulfilling the payment request using the credit available in the second credit component.
